(19) United States
(12) Patent Application Publication
(10) Pub. No.: US 2025/0256315 A1
(43) Pub. Date: Aug. 14, 2025

(54) SUB-AMBIENT TEMPERATURE ROLLING SYSTEM

(71) Applicant: GM GLOBAL TECHNOLOGY OPERATIONS LLC, Detroit, MI (US)

(72) Inventors: Daniel Ryan, fENTON, MI (US); Diptak BHATTACHARYA, Royal Oak, MI (US); Whitney Ann POLING, Rochester Hills, MI (US); Nicole ELLISON, Southfield, MI (US); Anil K. SACHDEV, Rochester Hills, MI (US); Andrew Clay BOBEL, Troy, MI (US)

(21) Appl. No.: 18/441,058

(22) Filed: Feb. 14, 2024

(51) Int. Cl. B21B 1/40; B21B 45/02; H01M 4/04

(52) U.S. Cl. CPC B21B 1/40; B21B 45/0209; H01M 4/0435

(57) ABSTRACT

A system configured to roll a metal into a foil. The system includes rollers spaced apart to receive the metal therebetween. The rollers are configured to press against the metal to roll the metal into the foil. A cooling sub-system is configured to cool the rollers with a coolant, thereby cooling the foil in contact with the rollers.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to sub-ambient temperature rolling systems configured to roll into a foil metals having relatively low melting temperatures.

Various manufacturing processes include rolling metals into foils. For example, lithium may be rolled into a thin foil to form an active layer of a battery anode. The lithium foil may be applied to any suitable current collector, such as a copper foil, to form the anode. Indium, tin, lead, and sodium are additional examples of metals that may be rolled into foils. In some cases, the metals may have a relatively low melting temperature.

### SUMMARY

The present disclosure includes a system configured to roll a metal into a foil. The system includes: rollers spaced apart to receive the metal therebetween, the rollers configured to press against the metal to roll the metal into the foil; and a cooling sub-system configured to cool the rollers with a coolant, thereby cooling the foil in contact with the rollers.

In further features, the metal includes at least one of lithium, indium, tin, lead, and sodium.

In further features, the foil is configured as an active layer of a battery electrode.

In further features, a chiller is configured to cool the coolant and maintain the coolant at a sub-ambient temperature.

In further features, the cooling sub-system is configured to circulate the coolant within the rollers.

In further features, the rollers define channels extending entirely through the rollers, the channels configured to circulate the coolant through the rollers.

In further features, the channels extend parallel to an axis of rotation of the rollers.

In further features, the channels extend non-linearly relative to an axis of rotation of the rollers.

In further features, the rollers each include a copper tube within the rollers configured to circulate the coolant within the rollers.

In further features, the rollers each define channels therein configured to circulate the coolant within the channels, the channels each defining an inlet and an outlet at a common side of the rollers.

In further features, the rollers define porous areas configured to circulate coolant within the rollers, each one of the porous areas is in fluid communication with an inlet and an outlet on opposite sides of the rollers.

In further features, the system defines a housing adjacent to one of the rollers, the housing defining a receptacle configured to receive the coolant and place the coolant in contact with the rollers.

In further features, the coolant is one of dry ice, silicone oil, and liquid argon.

In further features, a gap is defined between the housing and the roller, wherein the gap is configured to permit the coolant to seep out of the receptacle and onto an outer surface of the roller.

The present disclosure also includes a system configured to roll a metal into a foil. The system includes: rollers spaced apart to receive the metal therebetween and configured to press against the metal to roll the metal into the foil, the rollers including channels within the rollers configured to receive a coolant configured to cool the rollers; and a cooling sub-system configured to cool the coolant and circulate the coolant through the channels within the rollers, thereby cooling the rollers and the foil in contact with the rollers.

In further features, the metal includes at least one of lithium, indium, tin, lead, and sodium.

In further features, the coolant includes at least one of dry ice, silicone oil, and liquid argon.

The present disclosure further includes, in various features, a system configured to roll a metal into a foil. The system includes: rollers spaced apart to receive the metal therebetween and configured to press against the metal to roll the metal into the foil; housings each defining a receptacle, each one of the housings is adjacent to one of the rollers such that at least a portion of the rollers extends into the receptacles; and a coolant within the receptacles to cool the rollers and the foil in contact with the rollers.

In further features, gaps are defined between the housings and the rollers, the gaps provide a clearance for the rollers and permit the coolant to seep out of the receptacles and onto an outer surface of the rollers to coat the rollers and provide at least one of lubrication and an inert blanket on the rollers configured to resist moisture buildup on the rollers.

In further features, the coolant is housed within a container configured to be seated within the receptacle, the container shaped to conform to the rollers.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional view of an exemplary battery cell including current collectors coated with active layers;

FIG. 2 illustrates an exemplary rolling system in accordance with the present disclosure for rolling a metallic foil to reduce the thickness thereof;

FIG. 3 illustrates an exemplary cooling system in accordance with the present disclosure for colling rollers of the rolling system;

FIG. 4 is a side view of exemplary rollers in accordance with the present disclosure for use with the rolling system of FIG. 2, the rollers including linear cooling channels extending through the rollers;

FIG. 5 is a side view of exemplary rollers in accordance with the present disclosure for use with the rolling system of FIG. 2, the rollers including coolant tubes each with an inlet and an outlet on the same side of the rollers;

FIG. 6 is a side view of exemplary rollers in accordance with the present disclosure for use with the rolling system of FIG. 2, the rollers defining cooling channels each with an inlet and an outlet on the same side of the rollers;

FIG. 7 is a side view of exemplary rollers in accordance with the present disclosure for use with the rolling system of FIG. 2, the rollers defining non-linear cooling channels extending through the rollers;

FIG. 8 is a side view of exemplary rollers in accordance with the present disclosure for use with the rolling system of FIG. 2, the rollers defining porous areas between inlets and outlets located on opposite sides of the rollers;

FIG. 9A is a perspective view of an assembly configured to cool rollers of the rolling system of FIG. 1;

FIG. 9B is a perspective view of a housing and a roller of the assembly of FIG. 9A, the housing defining a receptacle for a coolant;

FIG. 9C is a cross-sectional view illustrating the receptacle of FIG. 9B filled with an exemplary cooling material;

FIG. 9D is a cross-sectional view illustrating a gap between the roller and the receptacle;

FIG. 9E is a cross-sectional view illustrating the receptacle of FIG. 9B filled with a liquid cooling material; and

FIG. 9F is a cross-sectional view illustrating the receptacle of FIG. 9B filled with a cooling pack.

In the drawings, reference numbers may be reused to identify similar and/or identical elements.

### DETAILED DESCRIPTION

The present disclosure includes a system configured to roll a metal into a foil. The metal may be any suitable metal including a relatively low melting temperature, such as one or more of lithium, indium, tin, lead, sodium, etc. The foil may be configured for use in any suitable automotive or non-automotive application. For example, the foil may be used as an active layer of a battery electrode. The battery may be configured for use with a vehicle, and may be configured for non-vehicular use as well.

Lithium, indium, tin, lead, sodium, and other metals with relatively low meting temperatures lack mechanical strength at room temperature, which presents challenges with rolling such metals into foils. For example, such metals are prone to tearing and fracturing during rolling, and may stick to the rollers. The present disclosure includes a cooling sub-system configured to reduce the temperature of the rollers, which thereby reduces the temperature of the metal being rolled by the rollers. The system of the present disclosure provides for rolling of the metals at sub-ambient temperatures in a dry room environment with a dew point below the rolling temperature of the metals. Reducing the temperature of metals with relatively low melting temperatures provides the metals with increased strength and hardness, which allows the metals to be rolled to thinner foil gauges.

The present disclosure chills the rollers in various ways, as described in detail herein. In general, the rollers may be chilled by flowing chilled coolant fluid through internal channels defined within the rollers, or the rollers may be externally chilled with chilled coolant. The external chilling also allows for chilled silicone oil to both chill the rollers and act as a rolling lubricant.

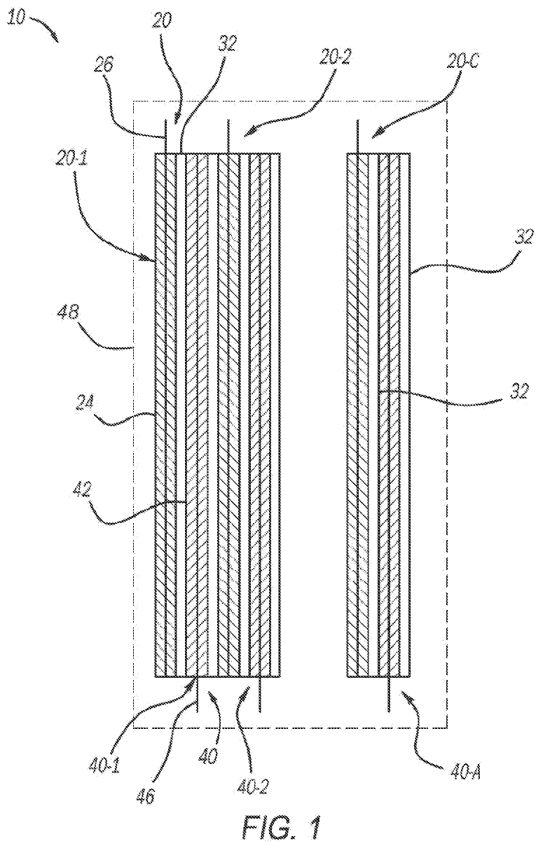

FIG. 1 illustrates an exemplary battery cell 10. The battery cell 10 may be configured for use in any suitable application, such as any suitable automotive or non-automotive application. The battery cell 10 includes C cathode electrodes 20, A anode electrodes 40, and S separators 32 arranged in a predetermined sequence in a stack 12, which is seated in an enclosure 48. C, A, and S are integers, which are each greater than one. In some examples, A=C+1. The C cathode electrodes 20-1, 20-2, . . . , and 20-C include cathode active layers 24 arranged on one or both sides of cathode current collectors 26. The A anode electrodes 40-1, 40-2, . . . , and 40-A include anode active layers 42 arranged on one or both sides of the anode current collectors 46.

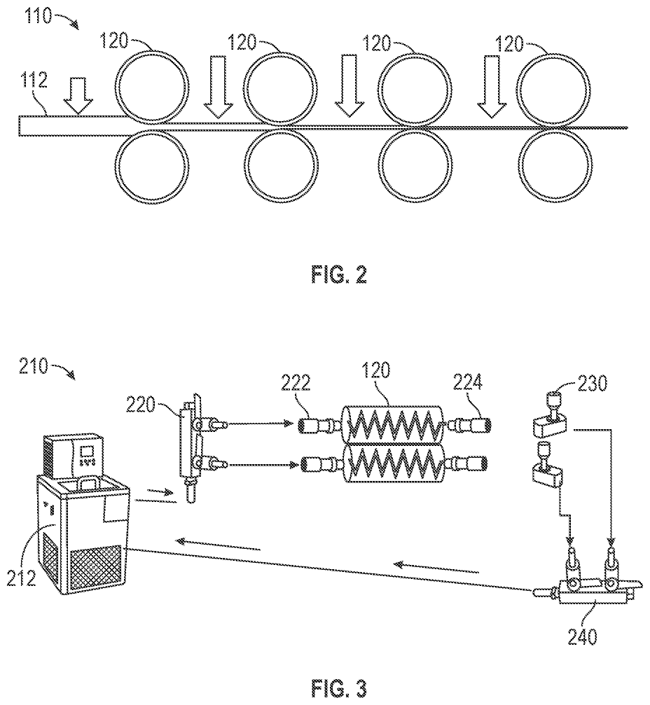

With reference to FIG. 2, the anode active layers 42 may include metallic foils 112 rolled using a rolling system 110 of the present disclosure. The rolling system 110 includes a plurality of rollers 120. The rollers are generally arranged in pairs. The rollers 120 of each pair are spaced apart to receive the metal therebetween, and configured to press against the metal to roll the metal into the foil 112. The rollers 120 may be made of any suitable material, such as any suitable thermally conductive material. Suitable materials for the rollers 120 include, but are not limited to, steel, aluminum, copper, etc. The rollers 120 may be formed in any suitable manner. For example, the rollers 120 may be forged, cast, formed by additive manufacturing, etc. The additive manufacturing may be metal additive manufacturing followed by machining. The rollers 120 may be coated with 50-100 microns of polypropylene/tungsten carbide/ceramic coating/Teflon coating/diamond-like carbon to facilitate cooling and lubrication, as further described herein.

With reference to FIG. 3, the rollers 120 are cooled with a cooling sub-system 210. The cooling sub-system 210 is configured to cool the rollers with any suitable coolant, thereby cooling the foil 112 in contact with the rollers, which strengthens the foil 112 and allows the foil 112 to be rolled to relatively stronger and thinner foil gauges. Examples of coolant that may be used to cool the rollers 120 include, but are not limited to, the following: silicone oil; liquid N₂; liquid Ar; and liquid CO₂.

In the example of FIG. 3, the cooling sub-system 210 includes a chiller 212. The chiller 212 may be any suitable chiller or other cooling device configured to cool a coolant to any suitable temperature, such as at least lower than an ambient or room temperature. The temperature may depend on the particular metal being rolled by the rolling system 110. For example, the temperature may be at or below the temperature at which the metal is subject to tearing or fracturing during rolling by the rollers 120. More specifically, the chiller 212 may be configured to circulate coolant in a range of 25° C. to−70° C. Liquid Ar or liquid N₂ are examples of coolants that may be used to achieve temperatures below −70° C. The metal being rolled may be at any suitable tem perature. For example, the temperature of the metal being rolled may be from −80° C. to 25° C., such as −40° C. or about −40° C.

The cooling sub-system 210 further includes a header 220, which is in fluid communication with both the chiller 212 and inlet rotary fittings 222. The inlet rotary fittings 222 are in cooperation with inlets of the rollers 120. Outlet rotary fittings 224 are in cooperation with outlets of the rollers 120. The rotary fittings 222 and 224 allow the rollers 120 to remain in fluid communication with the chiller 212 to receive the coolant while the rollers 120 rotate. Flow control valves 230 may be arranged at any suitable position about the cooling sub-system 210 to control flow of the coolant through the rollers 120 and regulate surface temperature of the rollers 120. Coolant from the rollers 120 flows to another header 240, which is in fluid communication with the chiller 212 to direct the coolant back to the chiller 212 and complete a cooling loop for the coolant.

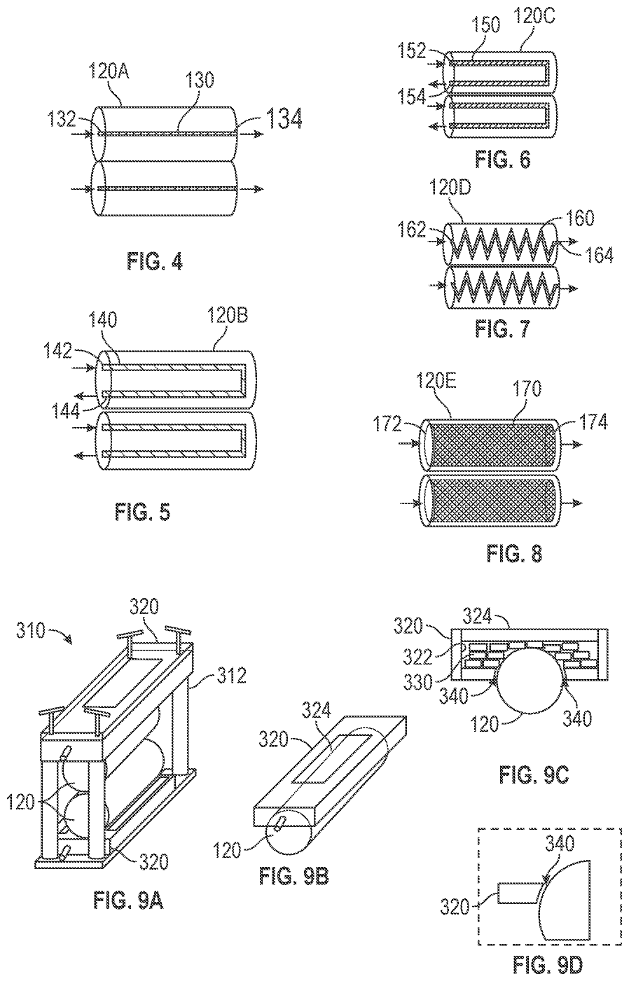

The rollers 120 may be configured in various different ways to be in fluid cooperation with the chiller 212 and be cooled by the coolant. For example, and with reference to FIG. 4, the rolling system 110 may include rollers 120A defining channels 130. The channels 130 are configured to receive chilled coolant from the chiller 212. The channels 130 are formed in any suitable manner, such as by being drilled into forged or cast solid rollers 120A. The channels 130 extend entirely through the rollers 120A along, or parallel to, an axis of rotation of the rollers 120A. Each one of the channels 130 includes an inlet 132 and an outlet 134 on opposite ends of the rollers 120A.

With reference to FIG. 5, the rolling system 110 may alternatively include rollers 120B. The rollers 120B are cast around tubes 140, which may be made of copper or any other suitable material. The tubes 140 define channels for the coolant. The tubes 140 each include an inlet 142 and an outlet 144 on a same side of the rollers 120B. The tubes 140 may alternatively extend completely through the rollers 120B.

With reference to FIG. 6, the rolling system 110 may include rollers 120C. The rollers 120C are made by any suitable additive manufacturing process to define a channel 150 within each roller 120C. The channels 150 are configured to receive chilled coolant from the chiller 212. Each one of the channels 150 includes an inlet 152 and an outlet 154. The inlet 152 and the outlet 154 may be on the same side of each one of the rollers 120C as illustrated, or on opposite sides of the rollers 120C.

FIG. 7 illustrates additional exemplary rollers 120D in accordance with the present disclosure for use with the rolling system 110. The rollers 120D define channels 160, which in the example illustrated extend entirely through the rollers 120D from inlets 162 to outlets 164 on opposite sides of the rollers 120D. The channels 160 are defined within the rollers 120D during additive manufacturing of the rollers 120D. The channels 160 extend non-linearly through the rollers 120D in generally a zig-zag fashion. The channels 160 are configured to receive chilled coolant from the chiller 212.

FIG. 8 illustrates exemplary rollers 120E for use with the rolling system 110. The rollers 120E define channels 170, which are generally porous areas of the rollers 120E each having an inlet 172 and an outlet 174 on opposite sides of the channels 170. The channels 170 are defined within the rollers 120E during additive manufacturing of the rollers 120E. The channels 170 are configured to receive chilled coolant from the chiller 212.

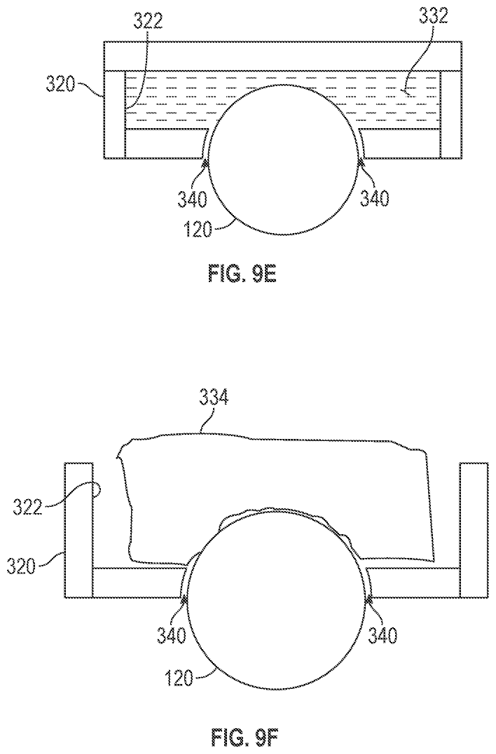

FIGS. 4-8 illustrate various rollers 120A-120E configured in accordance with the present disclosure to receive coolant within the rollers 120A-120E to cool the rollers 120A-120E, which in turn cools the metallic foil being rolled by the rolling system 110. The rollers 120 may be cooled in any other suitable manner. For example, FIG. 9A illustrates an exemplary cooling system 310 for directing any suitable coolant onto to an exterior surface of the rollers 120 to cool the rollers 120.

The cooling system 310 includes housings 320 configured to support the rollers 120 in any suitable manner that will allow the rollers 120 to rotate. FIG. 9B illustrates one of the housings 320 of one of the rollers 120. Each of the housings 320 for the other rollers 120 are the same or generally the same. The bottom housing 320 may include a floating floor with springs beneath the floor that compress as solid cooling media is added, but provide sufficient support to keep the coolant in contact with the roller 120.

Each housing 320 may include a cover 324, which is removable to permit access to a receptacle 322 defined by the housing 320. FIG. 9C illustrates the receptacle 322 backed with an exemplary coolant 330 in the form of dry ice. The receptacle 322 may be insulated with any suitable insulating material. The housing 320 includes any suitable outlet running between the receptacle 322 and an exterior of the housing 320 to provide an exit pathway for an outgassing to be collected by a fume hood, for example.

The housing 320 is adjacent to the roller 120, and a portion of the roller 120 extends into the receptacle 322. Within the receptacle 322, an outer surface of the roller 120 is in contact with the coolant 330 to cool the roller 120. As illustrated in FIG. 9D, a gap 340 is defined between the housing 320 and an outer surface of the roller 120 to allow the roller 120 to rotate. The gap 340 may be any suitable size. For example, the gap 340 may provide a rotational clearance of 0.1 mm-0.5 mm.

With reference to FIG. 9E, the receptacle 322 includes a coolant 332 in the form of a liquid coolant. The liquid coolant may be any suitable coolant, such as silicone oil or liquid argon, for example. The coolant 332 is in contact with the outer surface of the roller 120 to cool the roller 120. The gaps 340 between the housing 320 and the roller 120 allow the coolant 332 to seep down onto the roller 120 to lubricate the roller 120. When the coolant 332 is liquid argon, liquid argon fumes will leak from the gap 340 onto the roller 120 to provide an inert blanket to avoid moisture contamination on the roller 120. Silicone oil and other inert cooling fluids also avoid side-reactions and any possible contamination of lithium.

FIG. 9F illustrates a cooling pack 334 seated within the receptacle 322. The cooling pack 334 includes any suitable coolant, such as dry ice, liquid argon, etc. The coolant may be a liquid, solid, or a gel, for example. The cooling pack 334 includes a polymer or metal bag for housing the coolant. The bag is reusable and shaped to confirm to the outer surface of the roller 120. Between rolling operations carried out by the rolling system 110, the cooling pack 334 may be removed and placed in a refrigerator or freezer to keep the cooling pack 334 cool. The cooling pack 334 may also be configured as an instant ice pack, which when squeezed water interacts with a suitable chemical to start a reaction that lowers the temperature of the water to almost freezing. Chemical reactors in the cooling pack 334 may include ammonium nitrate, calcium ammonium nitrate, or urea.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A system configured to roll a metal into a foil, the system comprising:
rollers spaced apart to receive the metal therebetween, the rollers configured to press against the metal to roll the metal into the foil; and
a cooling sub-system configured to cool the rollers with a coolant, thereby cooling the foil in contact with the rollers.

2. The system of claim 1, wherein the metal includes at least one of lithium, indium, tin, lead, and sodium.

3. The system of claim 1, wherein the foil is configured as an active layer of a battery electrode.

4. The system of claim 1, further comprising a chiller configured to cool the coolant and maintain the coolant at a sub-ambient temperature.

5. The system of claim 1, wherein the cooling sub-system is configured to circulate the coolant within the rollers.

6. The system of claim 1, wherein the rollers define channels extending entirely through the rollers, the channels configured to circulate the coolant through the rollers.

7. The system of claim 6, wherein the channels extend parallel to an axis of rotation of the rollers.

8. The system of claim 6, wherein the channels extend non-linearly relative to an axis of rotation of the rollers.

9. The system of claim 1, wherein the rollers each include a copper tube within the rollers configured to circulate the coolant within the rollers.

10. The system of claim 1, wherein the rollers each define channels therein configured to circulate the coolant within the channels, the channels each defining an inlet and an outlet at a common side of the rollers.

11. The system of claim 1, wherein the rollers define porous areas configured to circulate coolant within the rollers, each one of the porous areas is in fluid communication with an inlet and an outlet on opposite sides of the rollers.

12. The system of claim 1, wherein the system defines a housing adjacent to one of the rollers, the housing defining a receptacle configured to receive the coolant and place the coolant in contact with the rollers.

13. The system of claim 12, wherein the coolant is one of dry ice, silicone oil, and liquid argon.

14. The system of claim 12, further comprising a gap defined between the housing and the roller, wherein the gap is configured to permit the coolant to seep out of the receptacle and onto an outer surface of the roller.

15. A system configured to roll a metal into a foil, the system comprising:
rollers spaced apart to receive the metal therebetween and configured to press against the metal to roll the metal into the foil, the rollers including channels within the rollers configured to receive a coolant configured to cool the rollers; and
a cooling sub-system configured to cool the coolant and circulate the coolant through the channels within the rollers, thereby cooling the rollers and the foil in contact with the rollers.

16. The system of claim 15, wherein the metal includes at least one of lithium, indium, tin, lead, and sodium.

17. The system of claim 15, wherein the coolant includes at least one of dry ice, silicone oil, and liquid argon.

18. A system configured to roll a metal into a foil, the system comprising:
rollers spaced apart to receive the metal therebetween and configured to press against the metal to roll the metal into the foil;
housings each defining a receptacle, each one of the housings is adjacent to one of the rollers such that at least a portion of the rollers extends into the receptacles; and
a coolant within the receptacles to cool the rollers and the foil in contact with the rollers.

19. The system of claim 18, wherein gaps are defined between the housings and the rollers, the gaps provide a clearance for the rollers and permit the coolant to seep out of the receptacles and onto an outer surface of the rollers to coat the rollers and provide at least one of lubrication and an inert blanket on the rollers configured to resist moisture buildup on the rollers.

20. The system of claim 18, wherein the coolant is housed within a container configured to be seated within the receptacle, the container shaped to conform to the rollers.
